(19) United States
(12) Patent Application Publication
(10) Pub. No.: US 2022/0204034 A1
(43) Pub. Date: Jun. 30, 2022

(54) METHOD FOR CARRYING OUT AN AUTOMATED OR AUTONOMOUS DRIVING OPERATION OF A VEHICLE

(71) Applicant: DAIMLER AG, Stuttgart (DE)

(72) Inventor: Fridtjof STEIN, Ostfildern (DE)

(21) Appl. No.: 17/610,808

(22) PCT Filed: Apr. 28, 2020
(86) PCT No.: PCT/EP2020/061667

§ 371 Date: Nov. 12, 2021

(30) Foreign Application Priority Data
May 15, 2019 (DE) 10 2019 003 430.9

(51) Int. Cl. B60W 60/00; B60W 40/06; B60W 40/105; B60W 30/14; B60W 30/095

(52) U.S. Cl. CPC B60W 60/0013; B60W 60/00184; B60W 60/00274; B60W 40/06; B60W 40/105; B60W 30/146; B60W 2556/40; B60W 2420/42; B60W 2420/52; B60W 2552/35; B60W 2554/4041; B60W 2554/60; B60W 30/0956

(57) ABSTRACT

A method for carrying out an automated or autonomous driving operation of a vehicle on a route involves generating a target trajectory and guiding the vehicle a function of the generated target trajectory. The target trajectory is generated as a function of the detected uneven surface when an uneven surface is detected on the route. When detecting an uneven surface running across the route transversely to the route and designed as a transverse uneven surface, in particular as a speed bump, the target trajectory is generated in such a way that the transverse uneven surface is driven over with a time delay for wheels of each individual axle of the vehicle.

### BACKGROUND AND SUMMARY OF THE INVENTION

Exemplary embodiments of the invention relate to a method for carrying out an automated or autonomous driving operation of a vehicle.

DE 10 2012 018 122 A1 discloses an autonomous driving of a motor vehicle on a route bypassing uneven surfaces by autonomously guiding the vehicle along the route as a function of a planned target trajectory. The method comprises a detection of uneven surfaces along the route and a planning of the target trajectory depending on the detected uneven surfaces.

Exemplary embodiments of the invention are directed to a method for carrying out an automated or autonomous driving operation of a vehicle that is improved compared to the prior art.

In a method for carrying out an automated, in particular highly automated, or autonomous driving operation of a vehicle, in particular a two-track vehicle, a target trajectory is generated along a route and the vehicle is guided as a function of the generated target trajectory, in particular guided along the route, in particular by an automated, in particular highly automated, or autonomous open- and/or closed-loop control of a lateral guidance and, for example, also a longitudinal guidance of the vehicle. If an uneven surface is detected along the route, the target trajectory is generated as a function of the detected uneven surface.

In accordance with the invention, when an uneven surface is detected that runs across the route as a transverse uneven surface, in particular as a speed bump, which spans the route, in particular completely, the target trajectory is generated in such a way that the transverse uneven surface is passed over with a time delay for the wheels of each individual axle of the vehicle.

In particular for multi-axle vehicles, in particular for vehicles with more than two axles, for example lorries, all axles of the vehicle are taken into account. The route of the vehicle is, for example, a roadway or a lane of a roadway, i.e., the transverse uneven surface can, for example, span the entire roadway or, for example, can only span the lane on which the vehicle is moving. As already mentioned, the transverse uneven surface is designed, for example, as a speed bump. Such a speed bump is also referred to as a traffic threshold, sleeping policeman, speed breaker, traffic calming measure, speed hump, or speed undulation. In the case of multi-axle vehicles, in particular vehicles with more than two axles, for example lorries, all axles of the vehicle are taken into account.

By means of the method according to the invention, the vehicle is thus automatically or autonomously guided when the transverse uneven surface is detected, in such a way that the vehicle drives over the transverse uneven surface with a time delay for the wheels of each individual axle, i.e., the transverse uneven surface is driven over by the vehicle at an angle. In general, it is particularly advantageous to drive around uneven surfaces and not over them, in order to avoid vertical pulses and thus vertical accelerations of the vehicle caused by the uneven surface and resultant adverse effects on the comfort of the vehicle occupants and/or, particularly in the case of transport vehicles, for example lorries, adverse effects on the load. However, this approach is not possible in the case of transverse uneven surfaces running across the roadway, in particular speed bumps. Although the solution according to the invention does not completely avoid vertical pulses and thus corresponding vertical accelerations of the vehicle, a considerable reduction of the vertical pulses and thus of the vertical accelerations of the vehicle is achieved compared to driving straight ahead over the transverse uneven surface. As a result, an increase in comfort for vehicle occupants of the vehicle, in particular in the case of a vehicle designed for passenger transport, for example a passenger car or bus, a protection of a load of the vehicle, in particular in the case of a vehicle designed as a transport vehicle, for example a lorry, and a protection of the vehicle, in particular of a running gear and/or a chassis and/or a body of the vehicle, against damage and thus an extension of the service life are achieved. The method according to the invention thus enables a higher drive-over comfort for vehicle occupants and/or a safe load transport. For example, the method according to the invention also makes it possible to drive over the transverse uneven surface at a speed than when driving over it in a straight line, while maintaining the same level of drive-over comfort and/or load transport safety.

A device is advantageously designed and set up to carry out the method, in particular designed and set up to generate the target trajectory and to guide the vehicle as a function of the generated target trajectory, in particular to guide it along the route, in particular by means of an automated, in particular highly automated, or autonomous open—and/or closed-loop control of the lateral guidance and, for example, also of the longitudinal guidance of the vehicle, and is designed and set up to generate the target trajectory as a function of the detected uneven surface when an uneven surface is detected along the route. The device is designed and set up to generate the target trajectory when an uneven surface is detected that runs transversely across the route as a transverse uneven surface, in particular as a speed bump, which spans the route, in particular completely, in such a way that the vehicle travels over the transverse uneven surface with a time delay for the wheels of each individual axle.

The device comprises, for example, a vehicle environment sensing system, a position determination device, a processing unit, and/or a vehicle actuation system. The processing unit comprises, for example, a behavior and planning module. The behavior and planning module comprises, for example, an internal environment map, a transverse uneven surface drive-over module and/or a trajectory generator.

For example, when the transverse uneven surface is detected, the target trajectory is generated in such a way that the vehicle approaches a first side of the route before driving over the transverse uneven surface, approaches an opposite, second side of the route while driving over the transverse uneven surface, and approaches the first side of the route again after driving over the transverse uneven surface. This makes it possible to drive over the transverse uneven surface at an angle in a particularly simple and safe manner without leaving the route as a result of driving over the transverse uneven surface at an angle. This approach thus optimally utilizes the width of the route in order to optimize the crossing of the transverse uneven surface at an angle.

For example, when the transverse uneven surface is detected, the target trajectory is generated in such a way that the transverse uneven surface is passed over at a speed that is reduced compared to a speed of the vehicle before the transverse uneven surface was detected. This means that the speed is advantageously reduced before reaching and driving over the transverse uneven surface in order to further reduce the vertical pulses, and can be increased again afterwards, i.e., after driving over the transverse uneven surface with all wheels of the vehicle.

For example, it can be provided that when the transverse uneven surface is detected, the target trajectory is generated in such a way that the transverse uneven surface is driven over at a fixed, predefined speed for transverse uneven surfaces. In other words, a fixed, predefined standard speed is used for driving over transverse uneven surfaces. In a further embodiment of the method, it can be provided, for example, that when the transverse uneven surface is detected, the target trajectory is generated in such a way that the transverse uneven surface is driven over at a predefined speed depending on a shape and/or height of the transverse uneven surface. In this way, the speed is adapted to the particular transverse uneven surface, in particular to its shape and/or height. In this way, for example, excessive speed reductions can be avoided in the case of small transverse uneven surfaces and, for example, very strong vertical pulses, which can lead to severe losses of comfort and/or damage to the load and/or damage to the vehicle, can also be avoided in the case of large transverse uneven surfaces.

The transverse uneven surface can, for example, be detected by means of an environment detection sensor system of the vehicle and/or by means of a digital map with transverse uneven surfaces recorded therein. In this way, for example, the shape and/or height of the particular transverse uneven surface can also be detected and taken into account in the manner described above when specifying the speed. The detection of the transverse uneven surface by means of the environment detection sensor system is particularly advantageous in the case of transverse uneven surfaces that are not recorded in the digital map, for example temporary transverse uneven surfaces, such as cable guides across the route. The detection of the transverse uneven surface by means of the digital map with the transverse uneven surfaces recorded therein provides, for example, additional security and redundancy in the detection of the transverse uneven surfaces and, for example, their shape and height.

If at least one object is detected on and/or next to the route, the target trajectory is advantageously additionally generated as a function of the at least one detected object. In this way, hazards caused by such objects or collisions with such objects are avoided. Advantageously, the target trajectory is then generated in such a way that the at least one object is driven around and the transverse uneven surface is driven over with a time delay for the wheels of each individual axle of the vehicle.

In the case of at least one object detected on and/or next to the route, which object is positioned on a side of the route after the transverse uneven surface, the target trajectory is advantageously generated in such a way that the vehicle approaches a side of the route opposite the object while driving over the transverse uneven surface. As a result, the vehicle moves away from the side of the route on which the object is positioned and thus away from the object, so that safe driving around the object is ensured.

In the case of at least one object detected on and/or next to the route, which object is positioned on a side of the route before the transverse uneven surface, the target trajectory is advantageously generated in such a way that the vehicle approaches a side of the route opposite the object before driving over the transverse uneven surface and approaches the side of the route on which the object is positioned while driving over the transverse uneven surface. In this way, the object is first driven around in a safe manner and then the transverse uneven surface can be driven over at an angle so that it is driven over with a time delay for the wheels of each individual axle of the vehicle.

If, due to one or more such objects, the target trajectory cannot be generated in such a way that the transverse uneven surface is driven over with a time delay for the wheels of each individual axle of the vehicle, this driving over of the transverse uneven surface at an angle is thus not carried out, and the transverse uneven surface must then be driven over accordingly, for example straight ahead. In other words, the object or objects on and/or next to the route, for example obstacles or other moving or stationary road users, are given higher priority than the reduction of the vertical pulses. The safety for the vehicle and the other objects, for example other moving or stationary road users, thus has priority over the reduction of the vertical pulses. In this case, however, it is advantageously provided that the target trajectory is planned in such a way that the transverse uneven surface is driven over at a further reduced speed compared to the driving over at an angle described above. This means that the speed of the vehicle is reduced to an even greater extent before driving over the transverse uneven surface in order to thus reduce the vertical pulses, in particular to an acceptable level, especially with regard to occupant comfort, load safety and protection of the vehicle.

Exemplary embodiments of the invention are explained in more detail below with reference to drawings.

### BRIEF DESCRIPTION OF THE DRAWING FIGURES

The Drawings Show:

FIG. 1 a schematic side view of a vehicle on a route with a transverse uneven surface,

FIG. 2 schematic plan view of the vehicle in different positions on the route with the transverse uneven surface and a vertical acceleration-time graph with vertical accelerations caused by driving over the transverse uneven surface,

FIG. 3 a schematic plan view of the vehicle in different positions on the route with the transverse uneven surface during a method for performing an automated or autonomous driving operation of the vehicle and a vertical acceleration-time graph with vertical accelerations caused by driving over the transverse uneven surface,

FIG. 4 a schematic plan view of the vehicle on the route with the transverse uneven surface and with an object laterally on and next to the route during the procedure for performing the automated or autonomous driving operation of the vehicle,

FIG. 5 a schematic view of a processing chain of the method for carrying out the automated or autonomous driving operation of the vehicle,

FIG. 6 a schematic view of an internal environment map of the processing chain, and

FIG. 7 a schematic view of a transverse uneven surface drive-over module of the processing chain.

Corresponding parts are provided with the same reference signs in all figures.

### DETAILED DESCRIPTION

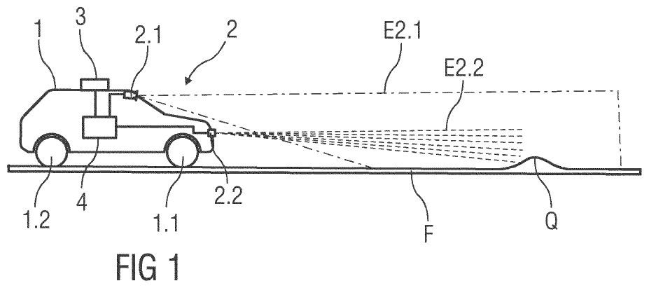

With reference to FIGS. 1 to 7, a method for carrying out an automated, in particular highly automated, or autonomous driving operation of a vehicle 1, in particular a two-track vehicle 1, on a route F is described below, which route has an uneven surface running transversely to the route F over the route F in the form of a transverse uneven surface Q, which spans the route F, for example a roadway or at least one lane of the roadway, in particular completely. The transverse uneven surface Q is designed, for example, as a speed bump. Such a speed bump is also referred to as a traffic threshold, sleeping policeman, speed breaker, traffic calming measure, speed hump, or speed undulation.

FIG. 1 shows a schematic representation of the vehicle 1 on the route F with the transverse uneven surface Q in a side view. The vehicle 1 has an environment detection sensor system 2, which here comprises a camera 2.1 and a lidar sensor 2.2 by way of example. FIG. 1 also shows a camera detection region E2.1 of the camera 2.1 and a lidar detection region E2.2 of the lidar sensor 2.2. It is clear from this that the transverse uneven surface Q can be detected by the vehicle 1 by means of the environment detection sensor system 2 of the vehicle 1, in this case by means of the camera 2.1 and by means of the lidar sensor 2.2, and in the method described here for carrying out the automated, in particular highly automated, or autonomous driving operation of the vehicle 1 is advantageously also actually detected by means of the environment detection sensor system 2.

In addition, the vehicle 1 has a position determination device 3 for determining a current position of the vehicle 1, in the example shown here in particular by means of a global navigation satellite system. This position determination device 3 advantageously comprises a digital map in which such transverse uneven surfaces Q, advantageously also the transverse uneven surface Q shown here, are recorded.

The transverse uneven surface Q can thus be detected by the vehicle 1, for example, by means of its environment detection sensor system 2 and/or by means of the digital map with the transverse uneven surfaces Q recorded therein. The detection of the transverse uneven surface Q by means of the environment detection sensor system 2 is particularly advantageous in the case of transverse uneven surfaces Q that are not recorded in the digital map, for example temporary transverse uneven surfaces Q, such as cable guides across the route F.

The vehicle 1 additionally has a processing unit 4, in particular a computing unit. Advantageously, the method or at least components of the method are carried out in this processing unit 4, as will be described in more detail below. In particular, sensor data SD of the environment detection sensor system 2 and/or data of the position determination device 3, in particular in combination with the digital map, are evaluated by means of this processing unit 4 in order to detect the transverse uneven surface Q and then to initiate appropriate measures, which will be described in more detail below.

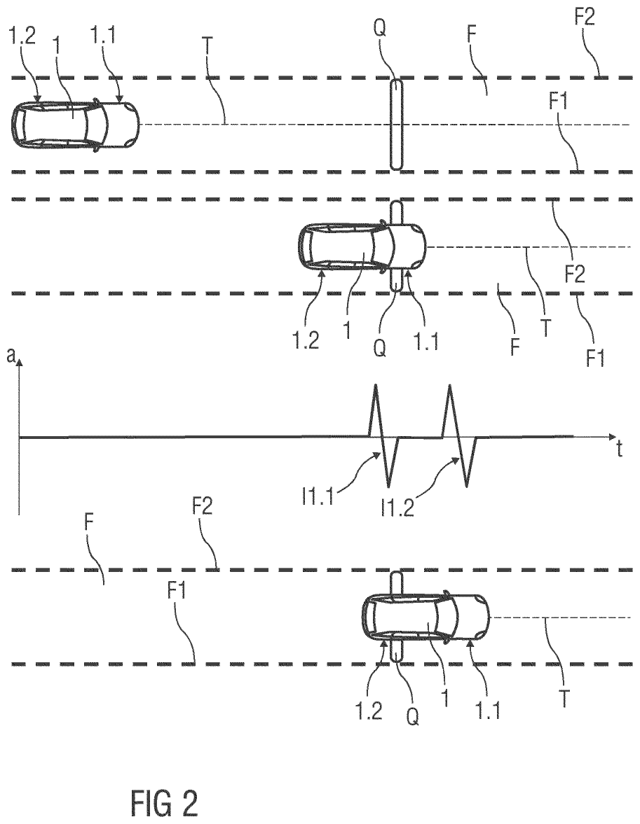

By driving over the transverse uneven surface Q, the vehicle 1 and thus the vehicle occupants and/or a load of the vehicle 1 are exposed to vertical pulses 11.1, 11.2 and thus to vertical accelerations a. FIG. 2 shows a schematic plan view of the vehicle 1 in various positions on the route F with the transverse uneven surface Q. In the uppermost illustration, the vehicle 1 is shown before passing over the transverse uneven surface Q, while the middle and lower illustrations show the vehicle passing straight over the transverse uneven surface Q, as can also be seen in particular from a depicted target trajectory T of the vehicle 1. In the middle illustration, the transverse uneven surface Q is driven over with wheels of a front axle 1.1, and in the lower illustration with wheels of a rear axle 1.2, wherein the transverse uneven surface Q is driven over with the wheels of each individual axle 1.1, 1.2 simultaneously in each case, due to the vehicle driving over straight.

FIG. 2 further shows a vertical acceleration a—time t graph with the vertical pulses 11.1 for the front axle 1.1 and vertical pulses 11.2 for the rear axle 1.2 caused by driving over the transverse uneven surface Q and a resulting course of the vertical acceleration a. These vertical excitations, i.e., the vertical pulses 11.1, 11.2 and thus the vertical accelerations a, impair a comfort of the vehicle occupants and/or a safety of the load, for example a load securing. This can cause fastening systems to come loose, for example. They also impair the quality of the load, i.e., the load can be damaged, for example.

A human driver who recognizes such a transverse uneven surface Q would modify his trajectory in such a way that he drives over it as comfortably as possible, i.e., in particular slowly and with minimal vertical accelerations a. Thus, when driving towards the transverse uneven surface Q, he would first reduce his speed and approach the transverse uneven surface Q at a slight angle. Since the vehicle 1 has a torsional stiffness, it is advisable to reduce the vertical accelerations a as much as possible by approaching the transverse uneven surface Q at an angle. Driving over the transverse uneven surface at an angle greatly dampens the vertical accelerations a, since only one wheel at a time of the vehicle 1 ever crosses the transverse uneven surface Q, while the other wheels remain in the same plane.

This advantageous approach is also achieved for the automated, in particular highly automated, or autonomously driving vehicle 1 on the route F by means of the method, described in more detail below, for carrying out the automated, in particular highly automated, or autonomous driving operation of the vehicle 1.

In this method, the target trajectory T is generated and the vehicle 1 is guided on the route F as a function of the generated target trajectory T, in particular by an automated, in particular highly automated, or autonomous open- and/or closed-loop control of a lateral guidance and, for example, also of a longitudinal guidance of the vehicle 1. If an uneven surface is detected on the route F, the target trajectory T is generated as a function of the detected uneven surface.

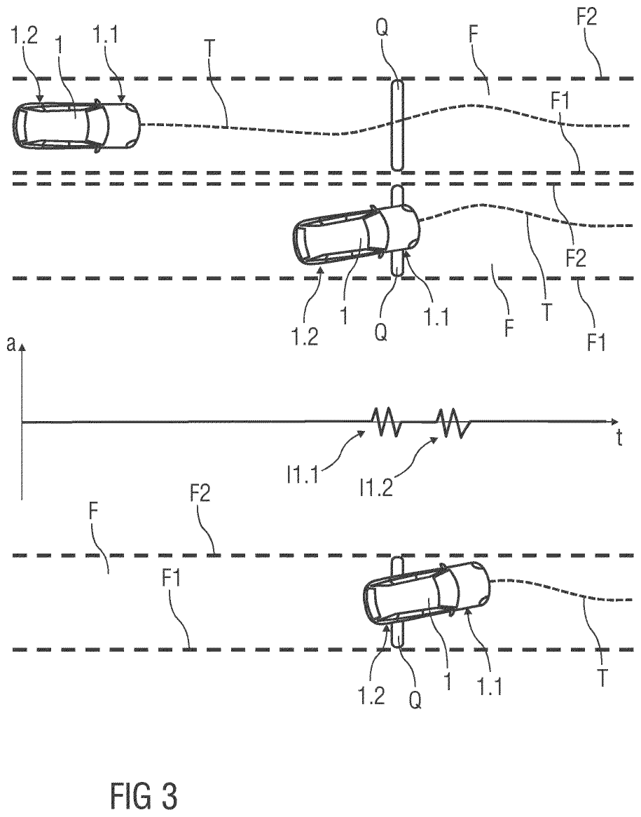

If the transverse uneven surface Q, in particular the speed bump, which runs across the route F transversely to the route F and spans the route F, in particular completely, is detected, then the target trajectory T is generated in such a way that the transverse uneven surface Q, as shown in FIG. 3, is driven over with a time delay for the wheels of each individual axle 1.1, 1.2 of the vehicle 1. This applies expediently to all axles 1.1, 1.2 of the vehicle 1, i.e., in the example shown here for both axles 1.1, 1.2 of the vehicle 1. If in other embodiments the vehicle 1 has more than the two axles 1.1, 1.2 shown here, for example in the case of vehicles 1 designed as lorries, then expediently all axles 1.1, 1.2 of the vehicle 1 are also taken into consideration in the method, as in the example shown here with two axles 1.1, 1.2. In other words, the target trajectory T is then likewise generated expediently in such a way that the transverse uneven surface Q is driven over with all axles 1.1, 1.2 of the vehicle 1 with a time delay for the wheels of each axle 1.1, 1.2 of the vehicle 1.

As shown in FIG. 3, the target trajectory T is generated in particular in such a way that the vehicle 1 approaches a first side F1, in particular longitudinal side, of the route F before driving over the transverse uneven surface Q, approaches a second, opposite side F2, in particular longitudinal side, of the route F while driving over the transverse uneven surface Q and approaches the first side F1 of the route F again after driving over the transverse uneven surface Q.

In FIG. 3, similarly to FIG. 2, the vehicle 1 is again shown in a schematic plan view in various positions on the route F with the transverse uneven surface Q, but this time during this method for carrying out the automated or autonomous driving operation of the vehicle 1. In the uppermost illustration, the vehicle 1 is again shown before driving over the transverse uneven surface Q, while the middle and lower illustrations again show the vehicle driving over the transverse uneven surface Q, wherein the transverse uneven surface Q is now driven over at an angle, in particular at a slight angle, by means of the method. The generated target trajectory T, which leads to driving over the transverse uneven surface Q in this way, is also shown. In the middle illustration, the transverse uneven surface Q is driven over with a time delay for the wheels of the front axle 1.1 of the vehicle 1, and in the lower illustration the transverse uneven surface Q is driven over with a time delay for the wheels of the rear axle 1.2 of the vehicle 1.

FIG. 3 also shows a vertical acceleration a—time t graph with the vertical pulses 11.1 for the front axle 1.1 and vertical pulses 11.2 for the rear axle 1.2 of the vehicle 1 caused by this driving over the transverse uneven surface Q at an angle, in particular at a slight angle, and a resulting curve of the vertical acceleration a. It can be seen that the number of vertical pulses 11.1, 11.2 is now doubled compared to the example according to FIG. 2, but their respective amplitudes are significantly reduced, advantageously halved, compared to FIG. 2. This results from the fact that both wheels of each axle 1.1, 1.2 now do not drive over the transverse uneven surface Q at the same time in each case, whereby a single pulse 11.1, 11.2 with a large amplitude is generated per axle 1.1, 1.2 of the vehicle 1, as shown in FIG. 2, and instead the transverse uneven surface Q is now driven over with each wheel individually, while the other wheels in each case remain in a common plane on the route F. This results in a separate pulse 11.1, 11.2 for each wheel as it passes over the transverse uneven surface Q, and thus in two pulses 11.1, 11.2 per axle 1.1, 1.2 of the vehicle 1, but each with a significantly lower amplitude. Due to these thus significantly lower vertical excitations, i.e., due to these now significantly lower vertical pulses 11.1, 11.2 and thus vertical accelerations a, the adverse effect on the comfort of the vehicle occupants and/or the safety of the load as well as the load quality are considerably reduced or substantially avoided.

In addition to the above-described generation of the target trajectory T in such a way that the wheels of each individual axle 1.1, 1.2 of the vehicle 1 pass over the transverse uneven surface Q with a time delay, it is advantageously provided that the target trajectory T is additionally also generated in such a way that the transverse uneven surface Q is passed over at a speed that is reduced compared to a speed of the vehicle 1 before the transverse uneven surface Q is detected. In other words, the speed is advantageously reduced before reaching and driving over the transverse uneven surface Q in order to further reduce the vertical pulses 11.1, 11.2, and can be increased again afterwards, i.e., after driving over the transverse uneven surface Q with all wheels of the vehicle 1.

For example, it can be provided that the target trajectory T is generated in such a way that the transverse uneven surface Q is travelled over at a fixed, predefined speed for transverse uneven surfaces Q. In other words, a fixed, predefined standard speed is used for travelling over transverse uneven surfaces Q. In a further embodiment of the method, it can be provided, for example, that the target trajectory T is generated in such a way that the transverse uneven surface Q is driven over at a speed predefined as a function of a shape and/or height of the transverse uneven surface Q. In this way, the speed is adapted to the existing transverse uneven surface Q, in particular to its shape and/or height. In this way, for example, excessive speed reductions can be avoided in the case of small transverse uneven surfaces Q and, for example, very strong vertical pulses 11.1, 11.2, which may lead to severe loss of comfort and/or damage to the load and/or damage to the vehicle 1, can also be avoided in the case of large transverse uneven surfaces Q.

The transverse uneven surface Q can be detected, as already described above, for example by means of the environment detection sensor system 2 of the vehicle 1 and/or by means of the digital map with transverse uneven surfaces Q recorded therein. In this way, for example, the shape and/or height of the particular transverse uneven surface Q can also be detected and taken into account in the manner described above when predefining the speed.

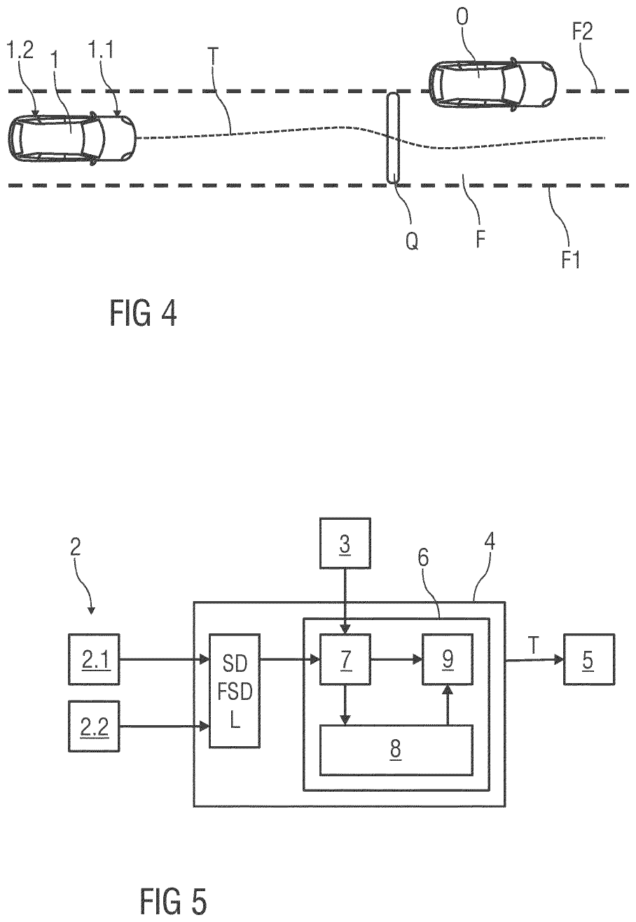

FIG. 4 shows an example of a method in the case of an object 0, for example another parked vehicle, on and/or next to the route F. Here, again, the vehicle 1 is shown in plan view on the route F with the transverse uneven surface Q during the method for carrying out the automated or autonomous driving operation of the vehicle 1, and now additionally the object 0, which in the example shown here is located laterally on and next to the route F, i.e., approximately half on the route F.

In the method for carrying out the automated or autonomous driving operation of the vehicle 1, the target trajectory T is advantageously generated additionally as a function of the detected object O when such an object O is detected on and/or next to the route F. This avoids hazards caused by such objects O or collisions with such objects O. Advantageously, the target trajectory T, as shown by way of example in FIG. 4, is then generated in such a way that the object O is driven around and the transverse uneven surface Q is driven over with a time delay for the wheels of each individual axle 1.1, 1.2 of the vehicle 1.

If, as shown in FIG. 4, the object O is positioned after the transverse uneven surface Q on one side of the route F, in this case on the second side F2 of the route F, then the target trajectory T is advantageously generated in such a way that the vehicle 1 approaches the side of the route F opposite the object O, in this case the first side F1 of the route F, while driving over the transverse uneven surface Q. This causes the vehicle 1 to move away from the side of the route F on which the object O is positioned, i.e., in this case from the second side F2 of the route F, and thus away from the object O, so that it can be driven around safely.

If, in another example, the object O is positioned in front of the transverse uneven surface Q on a side F1, F2 of the route F, the target trajectory T is advantageously generated in such a way that the vehicle 1 approaches a side F2, F1 of the route F opposite the object O before driving over the transverse uneven surface Q and, while driving over the transverse uneven surface Q, approaches the side F1, F2 of the route F on which the object O is positioned. In this way, the object 0 is first driven around in a safe manner and then the transverse uneven surface Q can be driven over at an angle so that it is driven over with a time delay for the wheels of each individual axle 1.1, 1.2 of the vehicle 1.

If, due to one or more such objects O, the target trajectory T cannot be generated in such a way that the transverse uneven surface Q is passed over with a time delay for the wheels of each individual axle 1.1, 1.2 of the vehicle 1, this driving over of the transverse uneven surface Q at an angle is thus not carried out, and instead the transverse uneven surface Q must then be driven over accordingly, for example straight ahead. In other words, the object O or the objects O on and/or next to the route F, for example obstacles or other moving or stationary road users, are given higher priority than the reduction of the vertical pulses 11.1, 11.2. The safety for the vehicle 1 and the other objects O, for example other moving or stationary road users, thus has priority over the reduction of the vertical pulses 11.1, 11.2.

In this case, however, it is advantageously provided that the target trajectory T is planned in such a way that the transverse uneven surface Q is driven over at a further reduced speed compared to the above-described driving over at an angle. In other words, the speed of the vehicle 1 is reduced to an even greater extent before driving over the transverse uneven surface Q in order to thereby reduce the vertical pulses 11.1, 11.2, in particular to an acceptable level, in particular with regard to occupant comfort, load safety and protection of the vehicle 1.

FIG. 5 schematically shows a processing chain of the method for carrying out the automated or autonomous driving operation of the vehicle 1. As already mentioned above, the method is carried out substantially by means of the processing unit 4 of the vehicle 1. Input values for this processing unit 4 are in particular sensor data SD of the environment detection sensor system 2 and data of the position determination device 3, in particular in combination with the digital map. These input values are used, in particular, for a fusion FSD of the sensor data SD and a localization L of the vehicle 1.

The processing unit 4 generates, in particular, the target trajectory T in the manner described above. The output value of this processing unit 4 is thus, in particular, the generated target trajectory T, which is fed to an actuator system 5 of the vehicle 1, i.e., which is used in particular for automated, in particular highly automated, or autonomous open- and/or closed-loop control of the lateral guidance and longitudinal guidance of the vehicle 1. In other words, the actuator system 5, comprising, in particular, a steering device, a drive train, and a braking device of the vehicle 1, is controlled in an open-loop and/or closed-loop fashion as a function of this target trajectory T.

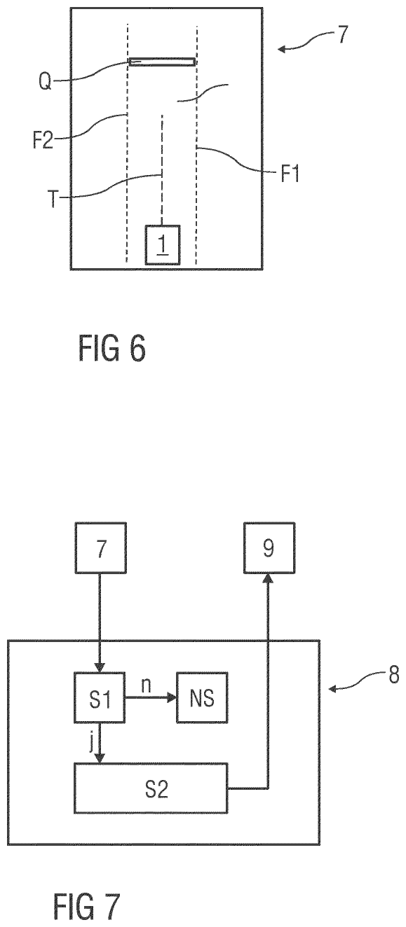

The processing unit 4 comprises a behavior and planning module 6 with an internal environment map 7, shown in more detail in FIG. 6, which comprises, for example, the information from the digital map and into which the sensor data SD, the fusion FSD of the sensor data SD and the localization L as well as the data from the position determination device 3 flow, a transverse uneven surface drive-over module 8, shown in more detail in FIG. 7, and a trajectory generator 9, in which the particular target trajectory T is generated.

FIG. 6 shows an example of the internal environment map 7 with the route F and the position of the vehicle 1, the transverse uneven surface Q on the route F and the previous target trajectory T of the vehicle 1. This internal environment map 7 or at least its current content can be generated, as already described, by means of the digital map of the vehicle 1 in conjunction with the data of the position determination device 3 and, for example, by means of the sensor data SD, the fusion FSD of the sensor data SD, and the localization L, for example also by means of the environment detection sensor system 2. It is possible to detect whether a transverse uneven surface Q is located on the route F, for example as also described above, by means of the environment detection sensor system 2 and/or by means of the digital map with the transverse uneven surfaces Q recorded therein.

FIG. 7 shows the transverse uneven surface drive-over module 8. The input value of said module is the internal environment map 7. In this transverse uneven surface drive-over module 8, it is first checked in a first step S1 whether a transverse uneven surface unit Q has been detected. If no transverse uneven surface unit Q was detected, here designated by the reference sign n for no, the processing in the transverse uneven surface drive-over module 8 is terminated with the current internal environment map 7 in a negative step NS and no modification of the target trajectory T is made. The check for a transverse uneven surface Q is then expediently carried out again during a further movement of the vehicle 1 along the route F with an internal environment map 7 updated by new data.

If a transverse uneven surface Q is detected in the first step S1, here denoted by the reference sign j for yes, in a second step S2 an instruction is given to the trajectory generator 9 to modify the target trajectory T, i.e., to generate it in such a way that it leads over the transverse uneven surface Q with the optimum angle, i.e., in particular in such a way that the transverse uneven surface Q is driven over with a time delay for the wheels of each individual axle 1.1, 1.2 of the vehicle 1 and that the speed of the vehicle 1 is adjusted in the manner described above, advantageously in accordance with the particular shape and/or height of the transverse uneven surface Q.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for carrying out an automated or autonomous driving operation of a vehicle on a route, the method comprising:
detecting whether there is an uneven surface on the route;
generating a target trajectory for the automated or autonomous driving operation of the vehicle, wherein when an uneven surface is detected on the route, the target trajectory is generated as a function of the detected uneven surface, and wherein when the detected uneven surface is a transverse uneven surface that runs transversely across the route and is a speed bump, the target trajectory is generated in such a way that the transverse uneven surface is driven over with a time delay for each wheel of each individual axle of the vehicle; and
guiding the vehicle as a function of the generated target trajectory.

12. The method of claim 11, wherein when the transverse uneven surface is detected, the target trajectory is generated in such a way that the vehicle approaches a first side of the route before driving over the transverse uneven surface, approaches a second, opposite side of the route while driving over the transverse uneven surface, and approaches the first side of the route again after driving over the transverse uneven surface.

13. The method of claim 11, wherein when the transverse uneven surface is detected, the target trajectory is generated in such a way that the transverse uneven surface is driven over at a speed that is reduced compared to a speed of the vehicle before the transverse uneven surface is detected.

14. The method of claim 11, wherein when the transverse uneven surface is detected, the target trajectory is generated in such a way that the transverse uneven surface is driven over at a fixed, predefined speed for transverse uneven surfaces.

15. The method of claim 11, wherein when the transverse uneven surface is detected, the target trajectory is generated in such a way that the transverse uneven surface is driven over at a speed that is predefined as a function of a shape or height of the transverse uneven surface.

16. The method of claim 11, wherein the transverse uneven surface is detected by an environment detection sensor system of the vehicle or by a digital map with transverse uneven surfaces recorded in the digital map.

17. The method of claim 11, wherein if at least one object is detected on or next to the route, the target trajectory is additionally generated as a function of the at least one detected object.

18. The method of claim 17, wherein the target trajectory is generated in such a way that the at least one object is driven around and the transverse uneven surface is driven over with a time offset for each of the wheels of each individual axle of the vehicle.

19. The method of claim 17, wherein when the at least one object is detected on or next to the route and is positioned on one side of the route after the transverse uneven surface, the target trajectory is generated in such a way that the vehicle approaches a side of the route opposite the detected at least one object while driving over the transverse uneven surface.

20. The method of claim 17, wherein when the at least one object is detected on or next to the route and is positioned on one side of the route in front of the transverse uneven surface, the target trajectory is generated in such a manner that the vehicle approaches a side of the route opposite the detected at least one object before driving over the transverse uneven surface and approaches a side of the route on which the detected at least one object is positioned while driving over the transverse uneven surface.
